(19) United States
(12) Patent Application Publication
(10) Pub. No.: US 2009/0244762 A1
(43) Pub. Date: Oct. 1, 2009

(54) RESIST PATTERN FORMING METHOD, MOLD STRUCTURE PRODUCING METHOD, MAGNETIC RECORDING MEDIUM PRODUCING METHOD, MAGNETIC TRANSFER METHOD AND MAGNETIC RECORDING MEDIUM

(75) Inventors: Yoichi Nishida, ODAWARA-SHI (JP); Hideyuki Kubota, ODAWARA-SHI (JP); Kazuhiro Niitsuma, ODAWARA-SHI (JP); Kazuyuki Usuki, ODAWARA-SHI (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/413,824

(22) Filed: Mar. 30, 2009

(30) Foreign Application Priority Data
Mar. 31, 2008 (JP) 2008-092265
Mar. 31, 2008 (JP) 2008-093466

(51) Int. Cl. G11B 5/02; B29C 39/00; B44C 1/22

(52) U.S. Cl. 360/55; 264/299; 216/41; G9B/5.026

(57) ABSTRACT

To provide a resist pattern forming method including: cleaning off fine powder at least on an edge of a base material to be processed; forming an imprint resist layer on a surface of the base material whose edge has been cleared of the fine powder; and forming a resist pattern on the surface of the base material by pressing, against the imprint resist layer, a concavo-convex pattern which is provided in a surface of a concavo-convex mold and which is composed of a plurality of convex portions and concave portions formed between the convex portions, so that the resist pattern is an inversion of the concavo-convex pattern.

### BACKGROUND OF THE INVENTION

1. Field of the Invention

The present invention relates to a resist pattern forming method; a method for producing a mold structure, including the resist pattern forming method; and a method for producing a magnetic recording medium, including the resist pattern forming method.

Also, the present invention relates to a magnetic transfer method for magnetically transferring information to a magnetic recording slave medium, using a magnetic transfer master carrier; and a magnetic recording medium.

2. Description of the Related Art

Microfabrication techniques for hard disks, optical disks, semiconductors and the like include nanoimprint lithography (NIL). The nanoimprint lithography includes a step of bringing a mold with a concavo-convex pattern on its surface into contact with a base material to be processed, on which an imprint resist layer has been formed, and thereby forming a resist pattern. In this step, there is such a problem that foreign matter such as fine powder enters places where the mold and the base material are in contact with each other.

U.S. Pat. No. 6,482,742 discloses a technique for reducing the effects of foreign matter attached to a mold and the front and back surfaces of a base material to be processed.

However, entry of only a small amount of foreign matter such as fine powder onto the processed surface of a base material can cause part of a resist pattern to be missing and also cause breakage of a concavo-convex pattern of a mold in the nanoimprint lithography, which is a problem.

In the nanoimprint lithography, in general, cleaning of equipment-related usage environments, molds, and surfaces (processed surfaces) of base materials has been considered.

However, measures for removing foreign matter, such as fine powder, attached to edges of the base materials have not at all been taken.

Also, in cases where a pattern is formed on surfaces of a large number of base materials, using a mold, ways of reducing amounts of foreign matter entering the processed surfaces have not at all been considered, which is regarded as a problem.

As a method of recording information such a servo signal onto a magnetic recording slave medium at one time, a method of using a magnetic transfer master carrier (so-called “magnetic transfer method”) is known.

A surface of the magnetic transfer master carrier used in this magnetic transfer method is provided with a magnetic portion placed correspondingly to information to be recorded onto the magnetic recording slave medium. When information is recorded onto the magnetic recording slave medium, the magnetic transfer master carrier is laid over the magnetic recording slave medium such that this magnetic portion is closely attached to the magnetic recording slave medium.

When a recording magnetic field is applied from outside, with the magnetic transfer master carrier closely attached to the magnetic recording slave medium, the recording magnetic field changes correspondingly to the magnetic portion, and information is recorded (magnetically transferred) to the magnetic recording slave medium based upon the recording magnetic field that has changed.

In this magnetic transfer method, if minute protrusions produced in a production process, etc. or attached matter such as fine powder is present on a surface of a circular magnetic recording slave medium to be closely attached to the magnetic transfer master carrier, the fine powder may possibly be sandwiched between the magnetic recording slave medium and the magnetic transfer master carrier, thus forming gaps there, when the magnetic transfer master carrier is closely attached to the magnetic recording slave medium. If the gaps are formed, magnetic transfer does not take place where the gaps are, and thus there is such a problem that imperfect signal transmission arises in which information is not recorded on the magnetic recording slave medium. Also, there is such another problem that the surface of the magnetic transfer master carrier may be broken by the fine powder.

Japanese Patent Application Laid-Open (JP-A) No. 2003-203335 discloses a method of removing minute protrusions or attached matter by polishing a surface of a magnetic recording slave medium before performing magnetic transfer. As just described, provided that attached matter or the like is removed from the surface of the magnetic recording slave medium in advance before performing the magnetic transfer, the occurrence of imperfect signal transmission caused by the attached matter or the like can be reduced to some extent.

However, even when the attached matter or the like has been removed from the surface of the magnetic recording slave medium, imperfect signal transmission may still arise, as fine powder present on a peripheral edge of the magnetic recording slave medium moves to the surface, which is a problem.

This problem is caused mainly because of the following reason: fine powder present on the peripheral edge of the magnetic recording slave medium, whose surface has been cleared of the attached matter or the like, moves to the surface, owing to the vibration that the magnetic recording slave medium receives, for example when it is conveyed in preparation for magnetic transfer or the like, and an air flow generated as the magnetic recording slave medium is closely attached to or separated from a magnetic transfer master carrier.

JP-A No. 2002-109730 discloses a method of removing fine powder (particles) on a surface (magnetic transfer surface) of a magnetic recording slave medium in order to improve adhesion between a magnetic transfer master carrier and the magnetic recording slave medium.

However, JP-A No. 2002-109730 does not disclose the fact that fine powder moves from a peripheral edge of a magnetic recording slave medium to a surface thereof, thereby reducing adhesion between a magnetic transfer master carrier and the magnetic recording slave medium.

JP-A 2004-326880 discloses a method of wiping away lubricant attached to an edge surface of a magnetic recording slave medium (magnetic disk). By wiping away unnecessary lubricant attached to the edge surface of the magnetic disk, the unnecessary lubricant is prevented from spreading onto the surface. When the spreading of the unnecessary lubricant onto the surface is prevented, the instability of a flying magnetic head, caused by the unnecessary lubricant, is removed.

However, JP-A No. 2004-326880 does not disclose the fact that fine powder moves from a peripheral edge of a magnetic recording slave medium to a surface thereof, thereby reducing adhesion between a magnetic transfer master carrier and the magnetic recording slave medium.

Meanwhile, JP-A No. 10-154321 discloses that when an edge surface of a substrate for a magnetic recording medium is rough, particles are generated from the edge surface, and the particles are attached to a surface of the substrate, thereby causing thermal asperity.

However, JP-A No. 10-154321 does not disclose the fact that fine powder moves from a peripheral edge of a magnetic recording slave medium to a surface thereof, thereby reducing adhesion between a magnetic transfer master carrier and the magnetic recording slave medium.

### BRIEF SUMMARY OF THE INVENTION

The present invention is aimed at solving the problems in related art and achieving the following object. An object of the present invention is to provide a resist pattern forming method whereby movement of fine powder from an edge of a base material to be processed to a surface of the base material is reduced; a method for producing a mold structure, including the resist pattern forming method; and a method for producing a magnetic recording medium, including the resist pattern forming method.

The present invention is also aimed at achieving the following other object. Another object of the present invention is to provide a magnetic transfer method whereby adhesion between a magnetic recording slave medium and a magnetic transfer master carrier is improved.

Means for solving the problems are as follows.

<1> A resist pattern forming method including: cleaning off fine powder at least on an edge of a base material to be processed; forming an imprint resist layer on a surface of the base material whose edge has been cleared of the fine powder; and forming a resist pattern on the surface of the base material by pressing, against the imprint resist layer, a concavo-convex pattern which is provided in a surface of a concavo-convex mold and which is composed of a plurality of convex portions and concave portions formed between the convex portions, so that the resist pattern is an inversion of the concavo-convex pattern.

As to the resist pattern forming method according to <1>, since the fine powder at least on the edge of the base material is cleaned off before the imprint resist layer is formed, movement of the fine powder from the edge of the base, material to the surface of the base material is reduced.

<2> A method for producing a mold structure, including: using the resist pattern forming method according to <1>, in which the base material is an original plate and the concavo-convex mold is an original master; and etching a surface of the original plate using, as a mask, a resist pattern that has been formed on the surface of the original plate by the resist pattern forming method so as to form hollows in the original plate and thus to obtain a mold structure which is composed of a substrate obtained by forming the follows in the original plate, and convex portions provided on a surface of the substrate.
<3> A method for producing a magnetic recording medium, including: using the resist pattern forming method according to <1>, in which the base material is a magnetic original plate including a magnetic layer and a supporting plate to support the magnetic layer, and the concavo-convex mold is a mold structure; and etching a surface of the magnetic layer using, as a mask, a resist pattern that has been formed on the surface of the magnetic layer by the resist pattern forming method so as to form hollows in the magnetic layer and thus to obtain a magnetic recording medium which is composed of the supporting plate and magnetic convex portions provided on a surface of the supporting plate.
<4> A magnetic transfer method including: initially magnetizing a magnetic recording slave medium by applying a DC magnetic field to the magnetic recording slave medium; cleaning off fine powder present on a chamfered surface and a peripheral surface of the magnetic recording slave medium, and also cleaning off fine powder present on a circular surface of the magnetic recording slave medium; and magnetically transferring information by applying a recording magnetic field, with a magnetic transfer master carrier closely attached to the magnetic recording slave medium, wherein the magnetic recording slave medium is shaped like a disc and has the chamfered surface at sides of the peripheral surface.

As to the magnetic transfer method according to <4>, before the information is magnetically transferred, the fine powder present on the chamfered surface and the peripheral surface of the magnetic recording slave medium is cleaned off, and also the fine powder present on the circular surface of the magnetic recording slave medium is cleaned off, thus, the fine powder present on the circular surface, the chamfered surface and the peripheral surface of the magnetic recording slave medium is removed, and adhesion between the magnetic recording slave medium and the magnetic transfer master carrier is thereby improved.

<5> The magnetic transfer method according to <4>, wherein in the cleaning of the magnetic recording slave medium, after the fine powder present on the chamfered surface and the peripheral surface of the magnetic recording slave medium has been cleaned off, the fine powder present on the circular surface of the magnetic recording slave medium is cleaned off.
<6> The magnetic transfer method according to one of <4> and <5>, wherein in the magnetic transfer of the information, the number of grains of the fine powder remaining on at least one of the circular surface, the chamfered surface and the peripheral surface after the cleaning of the magnetic recording slave medium is confirmed, and the information is magnetically transferred to the magnetic recording slave medium when the number of the grains is less than or equal to a permissible value, whereas the information is not magnetically transferred to the magnetic recording slave medium when the number of the grains is greater than the permissible value.
<7> The magnetic transfer method according to any one of <4> to <6>, wherein in the magnetic transfer of the information, the size of grains of the fine powder remaining on at least one of the circular surface, the chamfered surface and the peripheral surface after the cleaning of the magnetic recording slave medium is confirmed, and the information is magnetically transferred to the magnetic recording slave medium when the size of the grains is less than or equal to a permissible value, whereas the information is not magnetically transferred to the magnetic recording slave medium when the size of the grains is greater than the permissible value.
<8> A magnetic recording medium, produced using the magnetic transfer method according to any one of <4> to <7>.

According to the present invention, it is possible to solve the problems in related art and provide a resist pattern forming method whereby movement of fine powder from an edge of a base material to be processed to a surface of the base material is reduced; a method for producing a mold structure, including the resist pattern forming method; and a method for producing a magnetic recording medium, including the resist pattern forming method.

According to the present invention, it is also possible to provide a magnetic transfer method whereby adhesion between a magnetic recording slave medium and a magnetic transfer master carrier is improved.

### BRIEF DESCRIPTION OF THE DRAWINGS

FIG. 1 is an explanatory diagram showing a method of cleaning an edge of a base material to be processed, using a removing unit.

FIG. 2 is an explanatory diagram showing a method of cleaning a front surface of a base material to be processed, using a removing unit.

FIGS. 3A to 3E are explanatory diagrams showing an outline of a method for producing a mold structure.

FIGS. 4F to 4J are explanatory diagrams showing an outline of a method for producing an original master.

FIGS. 5K to 5M are explanatory diagrams showing an outline of a method for producing a magnetic recording medium.

FIGS. 6N to 6P are explanatory diagrams showing an outline of a step of producing a magnetic recording medium.

FIG. 7 is an explanatory diagram showing a procedure in a magnetic transfer method according to one embodiment of the present invention.

FIG. 8 is an explanatory diagram showing an initially magnetizing step.

FIG. 9 is an explanatory diagram showing a cross-section of a peripheral edge of a magnetic recording slave medium.

FIG. 10 is an explanatory diagram showing a method for removing fine powder on a peripheral edge of a magnetic recording slave medium.

FIG. 11 is an explanatory diagram showing the state of a surface of a magnetic recording slave medium after its peripheral edge has been cleaned.

FIG. 12 is an explanatory diagram showing a method for removing fine powder on a surface of a magnetic recording slave medium.

FIG. 13 is an explanatory diagram showing a magnetically transferring step.

FIG. 14 is an explanatory diagram schematically showing a cross-section of a magnetic transfer master carrier.

FIG. 15 is an explanatory diagram showing a procedure in a magnetic transfer method according to another embodiment of the present invention.

FIG. 16 is an explanatory diagram showing a procedure in a magnetic transfer method according to yet another embodiment of the present invention.

FIG. 17 is an explanatory diagram showing a procedure in a magnetic transfer method according to still yet another embodiment of the present invention.

### DETAILED DESCRIPTION OF THE INVENTION

### Resist Pattern Forming Method

A resist pattern forming method of the present invention includes a cleaning step, an imprint resist layer forming step and a resist pattern forming step. The following explains each of these steps.

### (Cleaning Step)

The cleaning step is a step of removing fine powder at least on an edge of a base material to be processed.

The base material is not particularly limited and is suitably selected in accordance with the intended use. Examples thereof include original plates made of silicon, etc., which are materials used for producing mold structures, and magnetic original plates, which are materials used for producing magnetic recording media such as discrete track media and bit-patterned media. The magnetic original plates each include at least a magnetic layer, and a supporting plate to support the magnetic layer.

The shape, size, thickness and the like of the base material are not particularly limited and are suitably selected in accordance with the intended use.

Specific examples of the base material include base materials (substrates) made of glass, quartz, aluminum, silicon, silicon carbide, and plastics such as polycarbonates and amorphous polyolefins.

Normally, fine powder, generated in a step of producing the base material and a step of producing a functional film formed on a surface of the base material, is attached to an edge of the base material. Thus, even if the surface of the base material has been cleaned and fine powder is thereby not attached to the surface, the fine powder on the edge possibly moves to the surface, for example when the base material is conveyed or stored in a predetermined container. Accordingly, in the cleaning step, the fine powder on the edge of the base material is removed in order to reduce the movement of the fine powder to the surface.

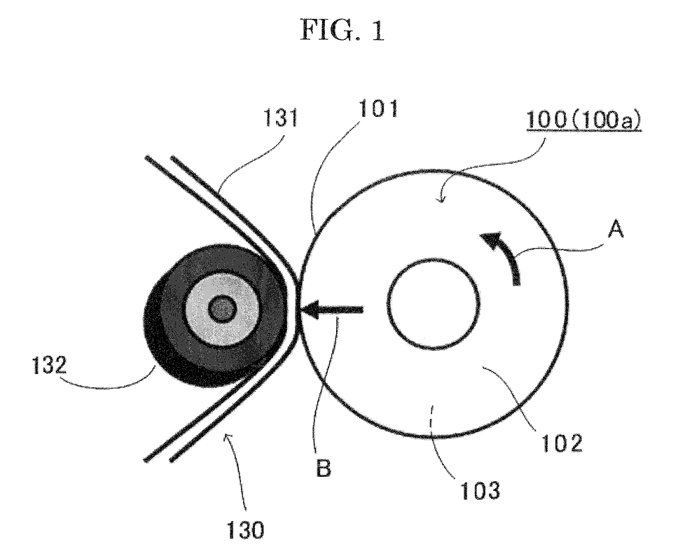

FIG. 1 is an explanatory diagram showing a method of cleaning an edge 101 of a base material 100 to be processed, using a removing unit 130. Here, a method of cleaning the edge 101 of the base material 100 is explained with reference to FIG.

The base material 100 shown in FIG. 1 serves as an original plate 100a which is in the shape of a disc and is a material for a mold structure. The removing unit 130 is composed of a wiping tape 131 and a sponge roller 132.

As shown in FIG. 1, the wiping tape 131 is pressed by the sponge roller 132 against the surface of the edge (peripheral edge) 101 of the base material 100 (100a). In other words, the wiping tape 131 is sandwiched between the edge 101 of the base material 100 (100a) and the sponge roller 132. The sponge roller 132 is fixed in a rotatable manner.

The base material 100 (100a) is rotated in the direction of the arrow A in FIG. 1, and fine powder on the surface of the edge 101 is wiped away with the wiping tape 131 at a contact section (indicated by the arrow B in FIG. 1) against which the wiping tape 131 is pressed by the sponge roller 132 under a fixed pressing surface pressure.

Note that the wiping tape 131 is appropriately wound such that a clean surface of it can always be used at the contact section.

If necessary, fine powder on a front surface 102 and a back surface 103 of the base material 100 may be removed.

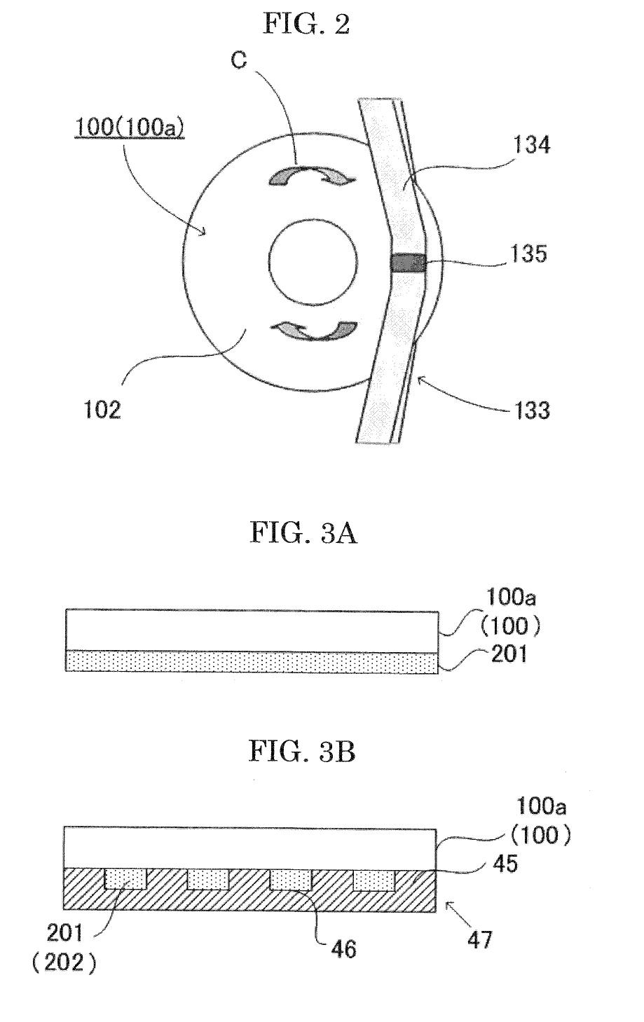

FIG. 2 is an explanatory diagram showing a method of cleaning the front surface 102 of the base material 100 (100a), using a removing unit 133. As shown in FIG. 2, a wiping tape 134 is pressed by a sponge pad 135 against the front surface 102 (upper surface) of the base material 100 (100a). The disc-shaped base material 100 (100a) is rotated in the direction of the arrow C in FIG. 2, and fine powder on the front surface 102 is wiped away with the wiping tape 134 at a place (contact section) against which the wiping tape 134 is pressed by the sponge pad 135. The position of the sponge pad 135 by which the wiping tape 134 is pressed against the front surface 102 is suitably adjusted.

Note that the term “fine powder” on the edge 101, etc. of the base material includes fine protrusions (minute protrusions) present on the surface of the base material, besides fine powder (dust and particles).

### (Imprint Resist Layer Forming Step)

The imprint resist layer forming step is a step of forming an imprint resist layer on a surface of the base material whose edge has been cleared of fine powder.

The composition, thickness, formation method (application method) and the like of the imprint resist layer are not particularly limited and are suitably selected in accordance with the intended use.

### (Resist Pattern Forming Step)

The resist pattern forming step is a step of forming a resist pattern on the surface of the base material by pressing, against the imprint resist layer, a concavo-convex pattern which is provided in a surface of a concavo-convex mold and which is composed of a plurality of convex portions and concave portions formed between the convex portions, so that the resist pattern is an inversion of the concavo-convex pattern.

The concavo-convex mold is used in so-called nanoimprint lithography. The concavo-convex mold is not particularly limited as long as it has on its surface a concavo-convex pattern composed of a plurality of convex portions and concave portions formed between the convex portions, and the concavo-convex mold is suitably selected in accordance with the intended use. Examples thereof include original masters used for producing mold structures, and mold structures used for producing magnetic recording media such as discrete track media and bit-patterned media.

Specific examples of the concavo-convex mold include known mold structures such as nickel molds, silicon molds, quartz molds, and plastic molds made of amorphous polyolefins, polydimethylsiloxane, etc.

Conditions, for example the force with which the concavo-convex mold is pressed and the length of time for which it is pressed, are suitably decided in accordance with the intended use.

The resist pattern forming step may employ a method selected, for example, from thermal imprinting, hot embossing, UV imprinting, room-temperature imprinting and soft lithography.

When the concavo-convex pattern of the concavo-convex mold is pressed against the imprint resist layer formed on the surface of the base material, the imprint resist layer enters the concave portions of the concavo-convex mold, conforming to the shape of the concave portions, and a resist pattern is thus formed. This resist pattern constitutes a pattern (inverted concavo-convex pattern) which is an inversion of the concavo-convex pattern of the concavo-convex mold.

As to the resist pattern forming step of the present invention, as described above, since a resist pattern is formed on the surface of the base material, at least whose edge has been cleared of fine powder in the cleaning step, movement of the fine powder from the edge to the surface, caused by conveyance of the base material, etc., is reduced. Thus, such an occurrence that the concavo-convex mold is pressed against the imprint resist layer on the base material, with fine powder sandwiched between the surface of the base material and the surface of the concavo-convex mold (apical surfaces of the convex portions), is reduced, and breakage of the convex portions of the concavo-convex mold, etc. is thereby reduced.

Furthermore, since decrease in the accuracy of the concavo-convex pattern of the concavo-convex mold is reduced, decrease in the pattern accuracy of the resist pattern is reduced as well.

The resist pattern forming method of the present invention can be utilized, for example, for a nanoimprinting process in a method for producing a mold structure for imprinting, a nanoimprinting process in a method for producing a magnetic recording medium such as a discrete track medium, a nanoimprinting process in a method for producing a high-density optical disk having data grooves or the like, a nanoimprinting process in a method for producing a semiconductor for memory, and a nanoimprinting process in a method for producing an optical device.

### [Method for Producing Mold Structure]

The following explains a method for producing a mold structure, including the resist pattern forming method of the present invention.

A method of the present invention for producing a mold structure includes the above-mentioned resist pattern forming method, wherein the base material is an original plate, and the concavo-convex mold is an original master.

The method of the present invention for producing a mold structure also includes etching a surface of the original plate using, as a mask, a resist pattern that has been formed on the surface of the original plate by the resist pattern forming method so as to form hollows in the original plate and thus to obtain a mold structure which is composed of a substrate obtained by forming the follows in the original plate, and convex portions provided on a surface of the substrate.

Specifically, the method of the present invention for producing a mold structure includes: cleaning off fine powder at least on an edge of an original plate; forming an imprint resist layer on a surface of the original plate whose edge has been cleared of the fine powder; forming a resist pattern on the surface of the original plate by pressing, against the imprint resist layer, a concavo-convex pattern which is provided in a surface of an original master and which is composed of a plurality of convex portions and concave portions formed between the convex portions, so that the resist pattern is an inversion of the concavo-convex pattern; and etching the surface of the original plate using the resist pattern as a mask so as to form hollows in the original plate and thus to obtain a mold structure which is composed of a substrate obtained by forming the follows in the original plate, and convex portions provided on a surface of the substrate.

In the case where surface hardness and/or microfabrication accuracy are/is not required for the mold structure to be produced, and the resist pattern itself can be used as a part of the mold structure, it is possible to omit the etching.

### <Cleaning Step>

The cleaning step is a step of removing fine powder at least on an edge of an original plate. The original plate is made of quartz, for example.

Details of the cleaning step are similar to those of the cleaning step in the above-mentioned resist pattern forming method.

### <Imprint Resist Layer Forming Step>

The imprint resist layer forming step is a step of forming an imprint resist layer on a surface of the original plate whose edge has been cleared of the fine powder.

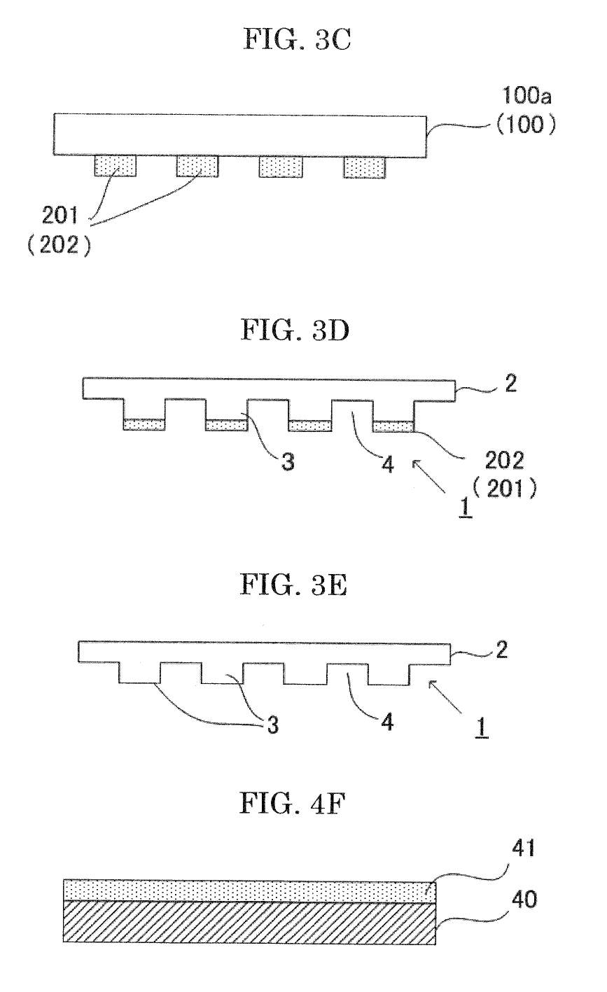

FIGS. 3A to 3E are explanatory diagrams showing an outline of a method for producing a mold structure. As shown in FIG. 3A, an imprint resist solution is applied onto a surface of an original plate 100a whose edge has been cleared of fine powder in the cleaning step, and an imprint resist layer 201 is thus formed. The imprint resist solution may contain thermoplastic resin, thermosetting resin, photocurable resin, etc.

### <Resist Pattern Forming Step>

The resist pattern forming step is a step of forming a resist pattern on the surface of the original plate by pressing, against the imprint resist layer, a concavo-convex pattern which is provided in a surface of an original master and which is composed of a plurality of convex portions and concave portions formed between the convex portions, so that the resist pattern is an inversion of the concavo-convex pattern.

### (Original Master)

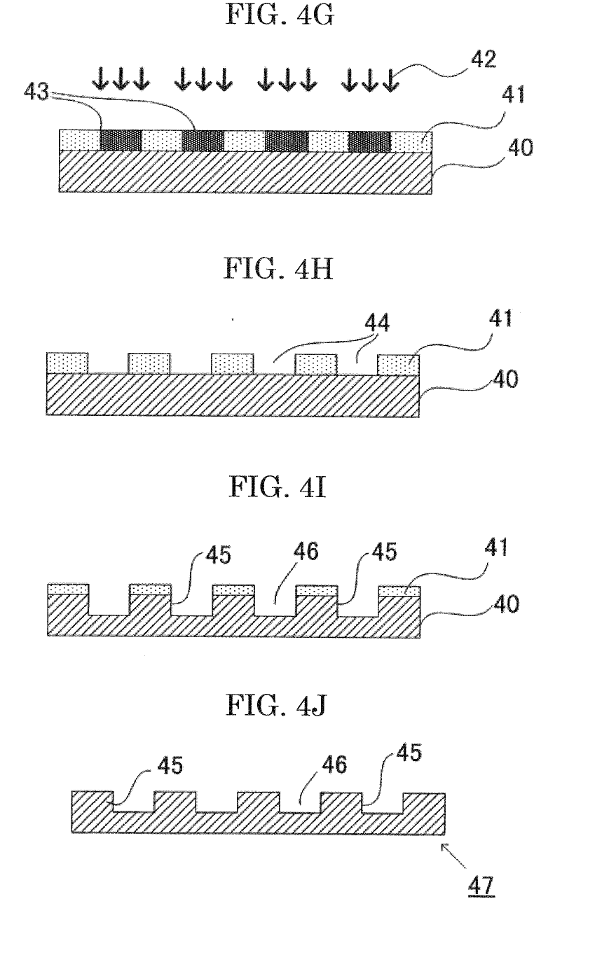

The original master is a concavo-convex mold used for producing a mold structure. FIGS. 4F to 4J are explanatory diagrams showing an outline of a method for producing an original master. The following explains a method for producing an original master with reference to FIGS. 4F to 4J.

As shown in FIG. 4F, a photoresist solution containing polymethyl methacrylate (PMMA), etc. is applied onto a silicon substrate 40 by spin coating or the like, and a photoresist layer 41 is thus formed.

Subsequently, as shown in FIG. 4G, the silicon substrate 40 with the photoresist layer 41 formed thereon is set on a rotary EB mastering device (not shown), then while the silicon substrate 40 is being rotated, the photoresist layer 41 is irradiated with (exposed to) an electron beam 42 modulated correspondingly to servo information or the like, and a minute pattern based upon the servo information or the like is written into the photoresist layer 41. In FIG. 4G, the exposed portion is denoted by the reference numeral 43.

Subsequently, as shown in FIG. 4H, the photoresist layer 41 is developed, and the exposed portion 43 is removed. When the exposed portion 43 has been removed, a resist pattern formed by the photoresist layer 41 appears on the silicon substrate 40.

Thereafter, as shown in FIG. 4I, a selective etching such as reactive etching (RIE) is carried out, using the resist pattern as a mask. By the selective etching, hollows are formed in the silicon substrate 40 at portions 44 where the resist pattern (photoresist layer 41) is not formed. After the selective etching, a plurality of convex portions 45 are formed on the surface of the silicon substrate 40 reduced in height, and concave portions 46 are formed between the convex portions 45.

Thereafter, as shown in FIG. 4J, by removing the resist pattern (photoresist layer 41) which remains on the convex portions 45, an original master 47 is obtained. In this original master 47, a concavo-convex pattern composed of the convex portions 45 and the concave portions 46 is formed.

As described above, the original master 47 is produced.

Here, FIGS. 3A to 3E are referred to again. As shown in FIG. 3B, the concavo-convex pattern composed of the convex portions 45 and the concave portions 46 of the original master 47 is pressed against the imprint resist layer 201 on the original plate 100a. The imprint resist layer 201 enters the concave portions 46 of the original master 47, conforming to the shape of the concave portions 46, and a resist pattern 202 composed of the imprint resist layer 201 is thus formed. This resist pattern 202 constitutes a pattern (inverted concavo-convex pattern) which is an inversion of the concavo-convex pattern of the original master 47.

The resist pattern 202 is cured. For instance, when the resist pattern 202 is formed by an imprint resist layer 201 containing a photocurable resin, a beam of light such as an ultraviolet ray is applied to the resist pattern 202 through the original plate 100a, and the imprint resist layer 201 is thereby cured.

Thereafter, as shown in FIG. 3C, when the original master 47 has been removed, the resist pattern 202 formed by the cured imprint resist layer 201 appears on the surface of the original plate 100a.

### <Original Plate Etching Step>

The original plate etching step is a step of etching the surface of the original plate using, as a mask, the resist pattern so as to form hollows in the original plate and thus to obtain a mold structure which is composed of a substrate obtained by forming the follows in the original plate, and convex portions provided on a surface of the substrate.

As shown in FIG. 3D, the original plate 100a is subjected to a selective etching such as RIE, with the resist pattern 202 used as a mask, so as to form hollows in the original plate 100a at places where the original plate 100a is not masked with the resist pattern 202. Then convex portions 3 are formed on the surface of a substrate 2 obtained by forming the follows in the original plate 100a. Concave portions 4 are formed between the convex portions 3. In this manner, a mold structure 1 in which a concavo-convex pattern composed of the convex portions 3 and the concave portions 4 is provided on the surface of the substrate 2 is obtained.

In the case where the resist pattern 202 remains on apical surfaces of the convex portions 3, the resist pattern 202 is appropriately removed as shown in FIG. 3E.

As to the method for producing the mold structure 1 of the present invention, as described above, since the resist pattern 202 is formed on the surface of the original plate 100a, at least whose edge has been cleared of fine powder in the cleaning step, movement of the fine powder from the edge to the surface, caused by conveyance of the original plate 100a, etc., is reduced. Thus, such an occurrence that the original master 47 is pressed against the imprint resist layer 201 on the original plate 100a, with fine powder sandwiched between the surface of the original plate 100a and the surface of the original master 47 (apical surfaces of the convex portions 45), is reduced, and breakage of the convex portions 45 of the original master 47, etc. is thereby reduced.

Furthermore, since decrease in the accuracy of the concavo-convex pattern of the original master 47 is reduced, decrease in the pattern accuracy of the resist pattern 202 is reduced as well.

### [Method for Producing Magnetic Recording Medium]

The following explains a method for producing a magnetic recording medium, including the resist pattern forming method of the present invention.

A method of the present invention for producing a magnetic recording medium includes the above-mentioned resist pattern forming method, wherein the base material is a magnetic original plate including a magnetic layer and a supporting plate to support the magnetic layer, and the concavo-convex mold is a mold structure.

The method of the present invention for producing a magnetic recording medium also includes etching a surface of the magnetic layer using, as a mask, a resist pattern that has been formed on the surface of the magnetic layer by the resist pattern forming method so as to form hollows in the magnetic layer and thus to obtain a magnetic recording medium which is composed of the supporting plate and magnetic convex portions provided on a surface of the supporting plate.

Specifically, the method of the present invention for producing a magnetic recording medium includes: cleaning off fine powder at least on an edge of a magnetic original plate including a magnetic layer and a supporting plate to support the magnetic layer; forming an imprint resist layer on a surface of the magnetic original plate whose edge has been cleared of the fine powder; forming a resist pattern on the surface of the magnetic original plate by pressing, against the imprint resist layer, a concavo-convex pattern which is provided in a surface of a mold structure and which is composed of a plurality of convex portions and concave portions formed between the convex portions, so that the resist pattern is an inversion of the concavo-convex pattern; and etching a surface of the magnetic layer using the resist pattern as a mask so as to form hollows in the magnetic layer and thus to obtain a magnetic recording medium which is composed of the supporting plate and magnetic convex portions provided on a surface of the supporting plate.

Further, the method of the present invention for producing a magnetic recording medium may include a step of filling gaps, formed between the magnetic convex portions on the surface of the supporting plate, with a nonmagnetic material.

### <Cleaning Step>

The cleaning step is a step of removing fine powder at least on an edge of a magnetic original plate. The magnetic original plate includes a magnetic layer, and a supporting plate to support the magnetic layer. The magnetic layer is made of Co, Co alloy, Fe, Fe alloy or the like, for example. More specifically, CoPtCr, and nonmagnetic oxides and nonmagnetic nitrides of CoPtCr can be suitably used. A protective film made of diamond-like carbon or the like may be formed on the magnetic layer. An intermediate layer made of Ru or the like, a soft magnetic underlying layer, etc. may be formed between the magnetic layer and the supporting plate.

The supporting plate is made of aluminum, glass, carbon, silicon or the like, for example, and generally the supporting plate is in the form of a disc with a central hole of 50 mm to 100 mm in outer diameter and has a thickness of 0.3 mm to 1.0 mm. It should, however, be noted that the present invention is not limited thereto.

Details of the cleaning step are similar to those of the cleaning step in the above-mentioned resist pattern forming method.

### <Imprint Resist Layer Forming Step>

The imprint resist layer forming step is a step of forming an imprint resist layer on a surface of the magnetic original plate whose edge has been cleared of the fine powder.

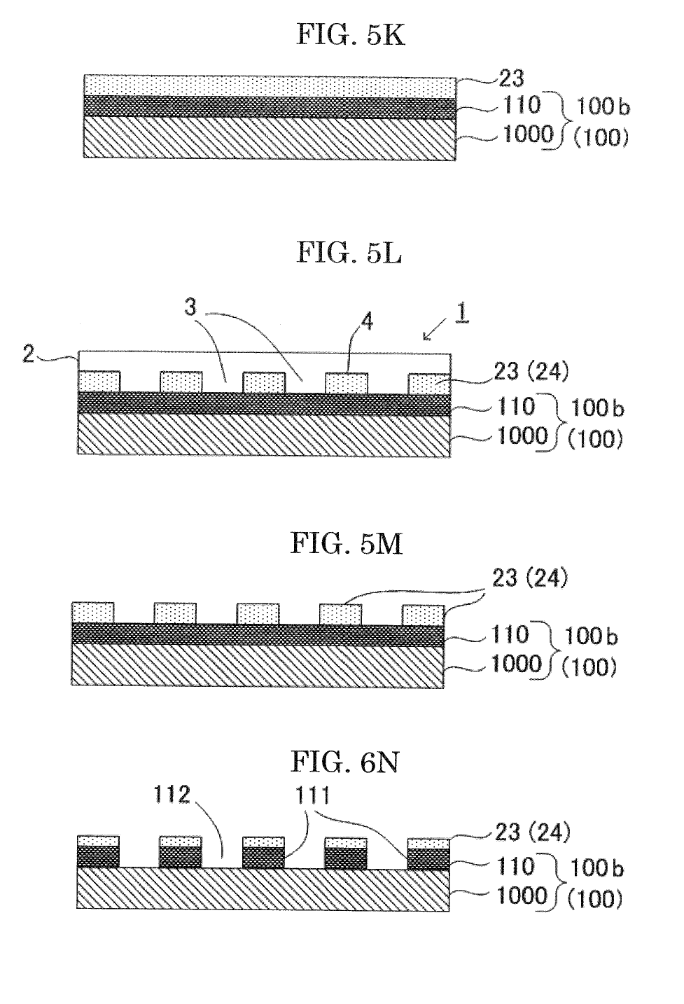

FIGS. 5K to 5M are explanatory diagrams showing an outline of a method for producing a magnetic recording medium. As shown in FIG. 5K, an imprint resist solution is applied onto a surface of a magnetic original plate 100b whose edge has been cleared of fine powder in the cleaning step, and an imprint resist layer 23 is thus formed.

The imprint resist solution may contain thermoplastic resin, thermosetting resin, photocurable resin, etc.

### <Resist Pattern Forming Step>

The resist pattern forming step is a step of forming a resist pattern on the surface of the magnetic original plate by pressing, against the imprint resist layer, a concavo-convex pattern which is provided in a surface of a mold structure and which is composed of a plurality of convex portions and concave portions formed between the convex portions, so that the resist pattern is an inversion of the concavo-convex pattern.

The mold structure is a concavo-convex mold used for producing a magnetic recording medium such as a discrete track medium or bit-patterned medium.

The mold structure is used in so-called nanoimprint lithography. The structure, material and the like of the mold structure are not particularly limited and are suitably selected in accordance with the intended use.

In the present embodiment, the mold structure 1 produced in the method for producing a mold structure is used.

As shown in FIG. 5L, the concavo-convex pattern composed of the convex portions 3 and the concave portions 4 of the mold structure 1 is pressed against the imprint resist layer 23 on the magnetic original plate 100b. The imprint resist layer 23 enters the concave portions 4 of the mold structure 1, conforming to the shape of the concave portions 4, and a resist pattern 24 composed of the imprint resist layer 23 is thus formed.

This resist pattern 24 constitutes a pattern (inverted concavo-convex pattern) which is an inversion of the concavo-convex pattern of the mold structure 1.

The resist pattern 24 is cured. For instance, when the resist pattern 24 is formed by an imprint resist layer 23 containing a photocurable resin, a beam of light such as an ultraviolet ray is applied to the resist pattern 24 through the mold structure 1 made of quartz, and the imprint resist layer 23 is thereby cured.

Thereafter, as shown in FIG. 5M, when the mold structure 1 has been removed, the resist pattern 24 formed by the cured imprint resist layer 23 appears on the surface of the magnetic original plate 100b.

### <Magnetic Layer Etching Step>

The magnetic layer etching step is a step of etching a surface of the magnetic layer using, as a mask, the resist pattern so as to form hollows in the magnetic layer and thus to obtain a magnetic recording medium which is composed of the supporting plate and magnetic convex portions provided on a surface of the supporting plate.

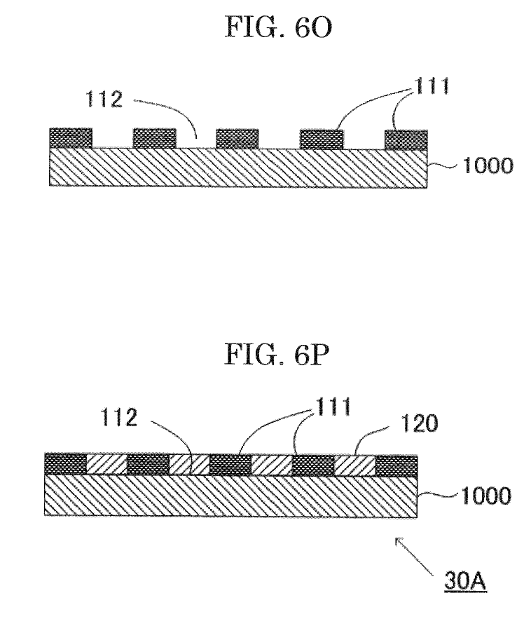

FIGS. 6N to 6P are explanatory diagrams showing an outline of a step of producing a magnetic recording medium.

As shown in FIG. 6N, the magnetic original plate 100b is subjected to a selective etching such as Ar ion beam etching, with the resist pattern 24 used as a mask, so as to form hollows in a magnetic layer 110 of the magnetic original plate 100b at places where the magnetic layer 110 is not masked with the resist pattern 24. Then magnetic convex portions 111 are formed on the surface of a supporting plate 1000. Concave portions 112 are formed between the magnetic convex portions 111. In this manner, a magnetic recording medium in which the magnetic convex portions 111 are provided on the surface of the supporting plate 1000 is obtained.

In the case where the resist pattern 24 remains on apical surfaces of the magnetic convex portions 111, the resist pattern 24 is appropriately removed as shown in FIG. 6O.

<Step of Filling with Nonmagnetic Material>

The step of filling with a nonmagnetic material is a step of filling gaps, formed between the magnetic convex portions on the surface of the supporting plate, with a nonmagnetic material.

As shown in FIG. 6P, the concave portions 112, which are the gaps between the magnetic convex portions, may be filled with a nonmagnetic material 120 exemplified by SiO₂, carbon, alumina, a resin such as polymethyl methacrylate (PMMA) or polystyrene (PS), a smoothing oil, etc.

The thickness of the nonmagnetic material to fill the concave portions 112 is normally made equal to the height of the magnetic convex portions 111.

In this manner, a magnetic recording medium 30A in which the concave portions 112 are filled with the nonmagnetic material 120 is obtained.

Further, if necessary, a protective layer made of diamond-like carbon (DLC), sputter carbon, etc. and a lubricant layer made of fluorine resin, etc. may be formed over the surfaces of the nonmagnetic material 120 and the magnetic convex portions 111.

As to the method of the present invention for producing a magnetic recording medium, as described above, since the resist pattern 24 is formed on the surface of the magnetic original plate 100b, at least whose edge has been cleared of fine powder in the cleaning step, movement of the fine powder from the edge to the surface, caused by conveyance of the magnetic original plate 100b, etc., is reduced. Thus, such an occurrence that the mold structure 1 is pressed against the imprint resist layer 23 on the magnetic original plate 100b, with fine powder sandwiched between the surface of the magnetic original plate 100b and the surface of the mold structure 1 (apical surfaces of the convex portions 3), is reduced, and breakage of the convex portions 3 of the mold structure 1, etc. is thereby reduced.

Furthermore, since decrease in the accuracy of the concavo-convex pattern of the mold structure 1 is reduced, decrease in the pattern accuracy of the resist pattern 24 is reduced as well.

The following explains a magnetic transfer method according to one embodiment of the present invention. The magnetic transfer method is a method in which information is magnetically transferred to a magnetic recording slave medium of a perpendicular magnetic recording system, using a magnetic transfer master carrier.

It should be noted that in other embodiments, information may be magnetically transferred to a magnetic recording slave medium of an in-plane magnetic recording system.

### [Magnetic Transfer Method]

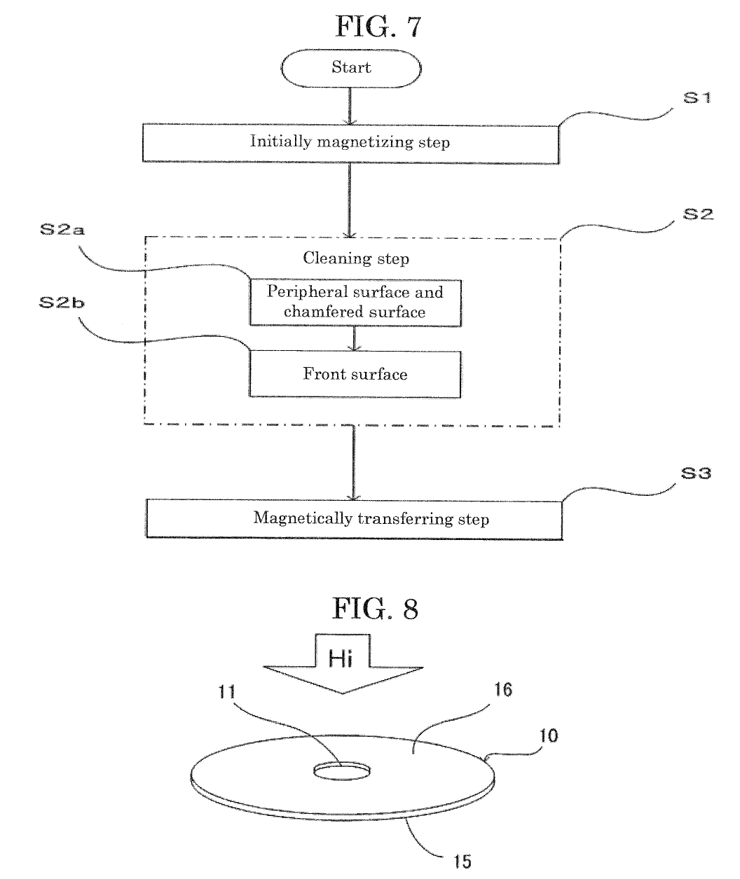

FIG. 7 is an explanatory diagram showing a procedure in a magnetic transfer method according to one embodiment of the present invention. As shown in FIG. 7, the magnetic transfer method includes an initially magnetizing step (S1), a cleaning step (S2) and a magnetically transferring step (S3). The following explains each of these steps in detail.

### (Initially Magnetizing Step)

The initially magnetizing step is a step of initially magnetizing a magnetic recording slave medium by applying a DC magnetic field to the magnetic recording slave medium.

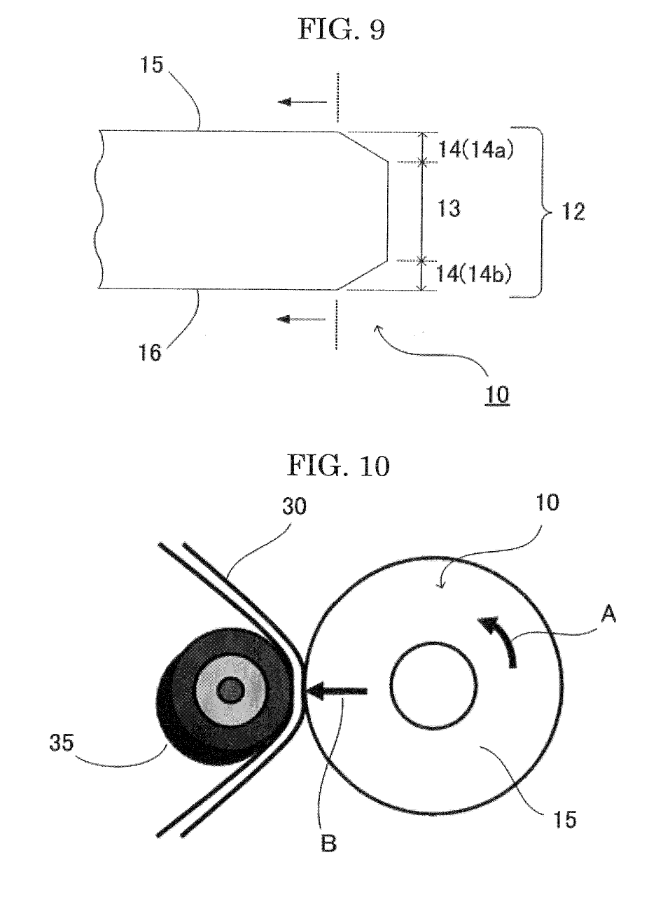

FIG. 8 is an explanatory diagram showing an initially magnetizing step. As shown in FIG. 8, a magnetic recording slave medium 10 is shaped like a disc and has a circular opening portion 11 at its center. FIG. 9 is an explanatory diagram showing a cross-section of a peripheral edge 12 of the magnetic recording slave medium 10.

The peripheral edge 12 of the magnetic recording slave medium 10 is an edge on the peripheral side of the magnetic recording slave medium 10, and the peripheral edge 12 includes a peripheral surface 13 and a chamfered surface 14. In FIG. 9, the surface on the upper side is a surface to be closely attached to a magnetic transfer master carrier and is referred to as “front surface 15”. Meanwhile, the surface on the lower side is referred to as “back surface 16”. The front surface 15 and the back surface 16 are both substantially circular in shape. Strictly speaking, the front surface 15 and the back surface 16 are not circular in shape because of the opening at the center; nevertheless, in the present specification, for the sake of facilitation of explanation, the front surface 15 and the back surface 16 are expressed as circular in shape.

The peripheral surface 13 is a side surface of the magnetic recording slave medium 10 and is placed on the outermost side of the magnetic recording slave medium 10. The peripheral surface 13 is shaped like a torus and placed in such a manner as to form a circumferential surface of the magnetic recording slave medium 10.

The chamfered surface 14 is formed at sides of the peripheral surface 13. The chamfered surface 14 is a place where the peripheral edge 12 has been chamfered. In the present embodiment, the chamfered surface 14 on the front surface 15 side is referred to as “chamfered surface 14a”, and the chamfered surface 14 on the back surface 16 side is referred to as “chamfered surface 14b”.

The magnetic recording slave medium 10 can be selected from known magnetic recording slave media each including a substrate made of glass, aluminum or the like, a soft magnetic layer, a nonmagnetic layer, a magnetic layer, a protective layer, etc.

In the present embodiment, the magnetic layer has magnetic anisotropy in a direction perpendicular to the front surface 15 of the magnetic recording slave medium 10.

In the initially magnetizing step, as shown in FIG. 8, a DC magnetic field (Hi) is applied to the magnetic recording slave medium 10 to initially magnetize it. For the application of the DC magnetic field (Hi), a predetermined magnetic field applying unit (not shown) is used.

In the present embodiment, the DC magnetic field (Hi) is applied in a direction perpendicular to the front surface 15 of the magnetic recording slave medium 10. The strength of the DC magnetic field (Hi) is made greater than or equal to that of the coercive force of the magnetic layer of the magnetic recording slave medium 10.

When the DC magnetic field (Hi) is applied to the magnetic recording slave medium 10, the magnetic layer is uniformly magnetized (initially magnetized) in the direction perpendicular to the front surface 15.

### (Cleaning Step)

The cleaning step is a step of removing fine powder present on the peripheral edge 12 (peripheral surface 13 and chamfered surface 14) of the magnetic recording slave medium 10 (S2a), and removing fine powder present on the front surface 15 of the magnetic recording slave medium 10 (S2b).

In this cleaning step, it is particularly desirable to remove (clean off) the fine powder present on the peripheral edge 12 first, and then remove (clean off) the fine powder present on the front surface 15. When the cleaning step is carried out with this order, the fine powder on the front surface 15 of the magnetic recording slave medium 10 can be removed more surely.

The following explains the cleaning step, giving an example in which the peripheral edge 12 is cleaned first, and then the front surface 15 is cleaned.

### <Cleaning of Peripheral Edge>

FIG. 10 is an explanatory diagram showing a method for removing fine powder on the peripheral edge 12 of the magnetic recording slave medium 10. As shown in FIG. 10, a wiping tape 30, a means of removing fine powder, is pressed against the surface of the peripheral edge 12 of the magnetic recording slave medium 10.

The wiping tape 30 is sandwiched between the peripheral edge 12 of the magnetic recording slave medium 10 and a sponge roller 35. This sponge roller 35 is fixed in a rotatable manner.

The magnetic recording slave medium 10 is rotated in the direction of the arrow A in FIG. 10, and fine powder on the peripheral surface 13 and the chamfered surface 14 is wiped away with the wiping tape 30 at a contact section (indicated by the arrow B) against which the wiping tape 30 is pressed by the sponge roller 35 under a fixed pressing surface pressure. The wiping tape 30 is appropriately wound such that a clean surface of it can always be used at the contact section.

Note that the term “fine powder” removed in the cleaning step of the present invention includes fine protrusions (minute protrusions) present on the surface of the magnetic recording slave medium 10, besides fine powder (dust and particles).

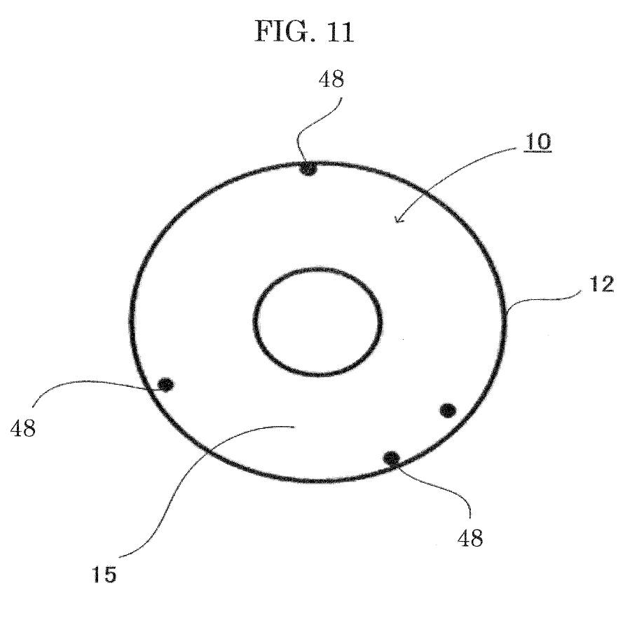

FIG. 11 is an explanatory diagram showing the state of the front surface 15 of the magnetic recording slave medium 10 after the peripheral edge 12 has been cleaned. As described above, when the peripheral edge 12 is cleaned, fine powder on the peripheral edge 12 is removed, but part of the fine powder removed may possibly fly in a dispersing manner and thus fine powder 48 may be attached to the front surface 15 of the magnetic recording slave medium 10 as shown in FIG. 11.

Accordingly, it is desirable to clean the front surface 15 of the magnetic recording slave medium 10 after cleaning the peripheral edge 12.

### <Cleaning of Front Surface>

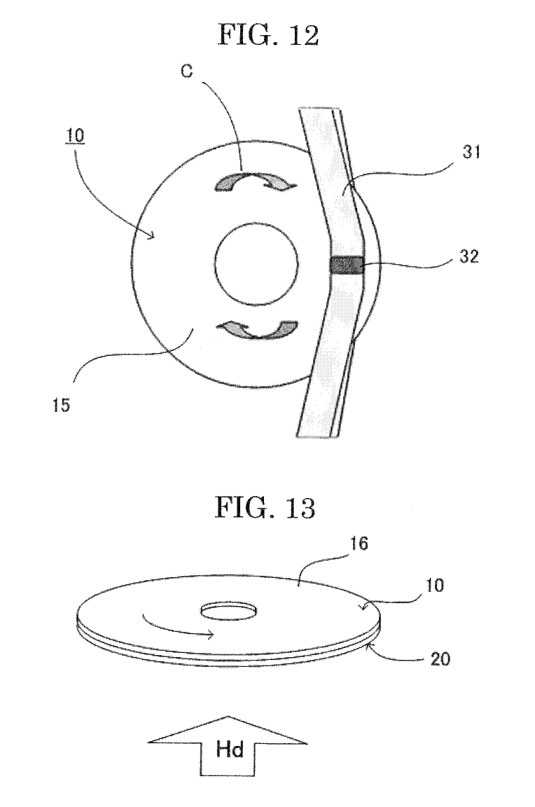

FIG. 12 is an explanatory diagram showing a method for removing fine powder on the front surface 15 of the magnetic recording slave medium 10. As shown in FIG. 12, a wiping tape 31 is pressed by a sponge pad 32 against the upper surface (front surface 15) of the magnetic recording slave medium 10. The magnetic recording slave medium 10 is rotated in the direction of the arrow C in FIG. 12, and fine powder on the front surface 15 is wiped away with the wiping tape 31 at a place (contact section) against which the wiping tape 31 is pressed by the sponge pad 32. The position of the sponge pad 32 by which the wiping tape 31 is pressed against the front surface 15 is suitably adjusted.

For the cleaning of the front surface 15, besides the wiping tape, selection from a variety of cleaning tapes including a burnishing tape is possible. These tapes may be used in combination. Besides, the front surface 15 may be cleaned by performing head burnishing, using a burnishing head or glide head.

### (Magnetically Transferring Step)

The magnetically transferring step is a step of magnetically transferring information by applying a recording magnetic field, with a magnetic transfer master carrier closely attached to the magnetic recording slave medium.

FIG. 13 is an explanatory diagram showing a magnetically transferring step. As shown in FIG. 13, a magnetic transfer master carrier 20 is closely attached to the magnetic recording slave medium 10, then a recording magnetic field is applied, with these closely attached to each other.

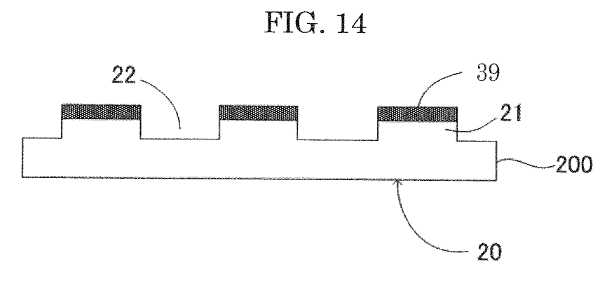

FIG. 14 is an explanatory diagram schematically showing a cross-section of the magnetic transfer master carrier 20. As shown in FIG. 14, the magnetic transfer master carrier 20 includes a base material 200 having, on its surface, convex portions 21 placed correspondingly to information to be recorded on the magnetic recording slave medium 10; and a magnetic layer 39 formed at least on apical surfaces of the convex portions 21. Examples of the information to be recorded include a servo signal for servo tracking. The base material 200 is made, for example, of silicon, glass, nickel or the like, and the magnetic layer 39 has magnetic anisotropy in a direction perpendicular to the surface of the base material 200. In the present embodiment, a protective layer made of carbon, etc., and/or the like may be formed over the surface of the magnetic layer 39.

In the magnetically transferring step, the magnetic transfer master carrier 20 is pressed against the magnetic recording slave medium 10, such that its surface with the magnetic layer 39 comes into contact with the upper surface (front surface 15) of the magnetic recording slave medium 10.

Since fine powder (particles, etc.) has been removed from the peripheral edge 12 (peripheral surface 13 and chamfered surface 14) and the front surface 15 of the magnetic recording slave medium 10, formation of gaps between the front surface 15 of the magnetic recording slave medium 10 and the magnetic layer 39 of the magnetic transfer master carrier 20, caused by the fine powder being sandwiched between them, is reduced, and adhesion between the magnetic recording slave medium 10 and the magnetic transfer master carrier 20 is thereby improved.

With the magnetic transfer master carrier 20 and the magnetic recording slave medium 10 closely attached to each other as described above, a recording magnetic field (Hd) which acts in the opposite direction to the direction of the DC magnetic field (Hi) applied in the initially magnetizing step is applied using a predetermined magnetic field applying unit (not shown).

The recording magnetic field (Hd) may be applied while the magnetic recording slave medium 10 and the magnetic transfer master carrier 20 are being rotated by a predetermined rotating unit (not shown).

The strength of the recording magnetic field (Hd) is preferably equivalent to 40% to 130% of that of the coercive force of the magnetic layer of the magnetic recording slave medium 10.

When the recording magnetic field (Hd) is thus applied, the information that the magnetic transfer master carrier 20 has is magnetically transferred to the magnetic recording slave medium 10.

Specifically, when the recording magnetic field (Hd) is applied, a magnetic flux is absorbed into the magnetic layer 39 of the magnetic transfer master carrier 20, and the magnetic field becomes strong at the convex portions 21 on which the magnetic layer 39 is formed, whereas the magnetic field becomes relatively weak at gaps (concave portions 22) between the convex portions 21. Thus, a magnetic field pattern is formed, magnetization at predetermined places on the magnetic layer of the magnetic recording slave medium 10 is reversed by this magnetic field pattern, and the information is recorded.

As described above, since formation of gaps between the magnetic recording slave medium 10 and the magnetic transfer master carrier 20, caused by fine powder, is reduced, and adhesion between the magnetic recording slave medium 10 and the magnetic transfer master carrier 20 is improved, the occurrence of imperfect signal transmission at the time of magnetic transfer is reduced. Also, breakage of the magnetic transfer master carrier 20 caused by the fine powder is reduced.

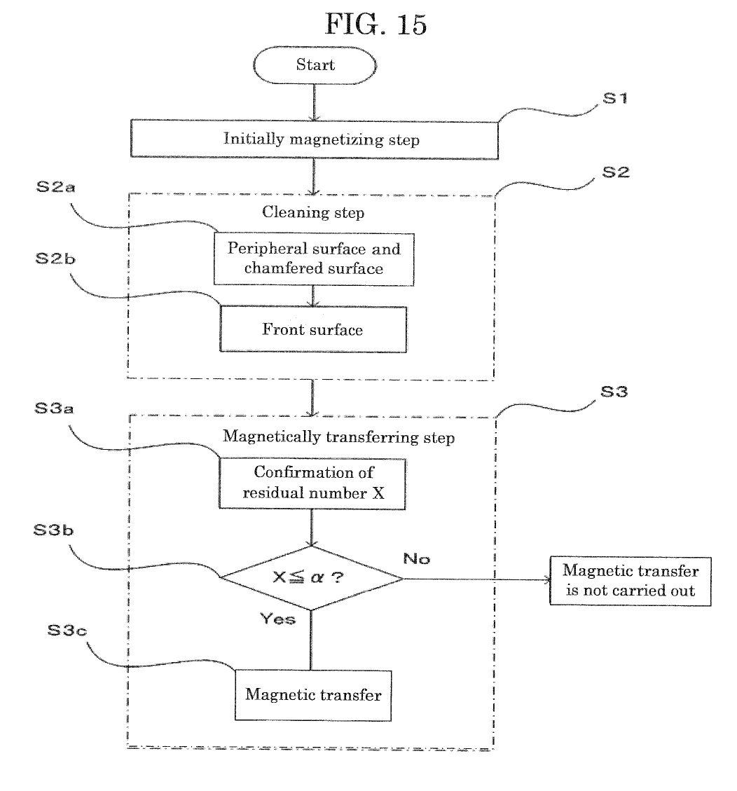

FIG. 15 is an explanatory diagram showing a procedure in a magnetic transfer method according to another embodiment of the present invention. Although the magnetic transfer method of this embodiment includes an initially magnetizing step (S1), a cleaning step (S2) and a magnetically transferring step (S3) similarly to the method of the above-mentioned embodiment, the method of this embodiment differs from the method of the above-mentioned embodiment as follows: in the magnetically transferring step (S3), the number (residual number) of grains of fine powder remaining on the peripheral edge 12 and the front surface 15 of the magnetic recording slave medium 10 is confirmed, and whether magnetic transfer is possible or impossible is judged based upon the result of the confirmation. The following explains the magnetically transferring step (S3) in the magnetic transfer method according to this embodiment.

As shown in FIG. 15, after the cleaning step (S2), the number of grains of fine powder remaining on the peripheral edge 12 and the front surface 15 of the magnetic recording slave medium 10 is confirmed. Specifically, a visual external inspection is carried out using Micro-MAX (VMX-2100, manufactured by Vision Psytec Co., Ltd.), for example, and the number (residual number) X of grains of fine powder remaining on the peripheral edge 12 and the front surface 15 is calculated (S3a). Here, the residual number of the grains of the fine powder on the peripheral edge 12 is denoted by X₁, and the residual number of the grains of the fine powder on the front surface 15 is denoted by X₂.

Subsequently, as shown in FIG. 15, whether magnetic transfer is possible or impossible is judged (S3b) by judging whether or not the residual number X exceeds a permissible value α. The permissible value α is a value which is appropriately set, for example based upon a result concerning an occurrence of imperfect signal transmission at the time of magnetic transfer. Here, the permissible value for the number (residual number) X₁ of the grains of the fine powder on the peripheral edge 12 is denoted by α₁, and the permissible value for the number (residual number) X₂ of the grains of the fine powder on the front surface 15 is denoted by α₂.

When the residual number X is less than or equal to the permissible value a, magnetic transfer is carried out in a manner similar to the above-mentioned embodiment. Meanwhile, when the residual number X is greater than the permissible value α, magnetic transfer is not carried out.

In the judgment (S3b), for example, magnetic transfer may be judged to be possible only when the residual number X₁ is less than or equal to the permissible value a, and the residual number X₂ is less than or equal to the permissible value α₂; alternatively, magnetic transfer may be judged to be possible at least when the residual number X₂ is less than or equal to the permissible value α₂.

The magnetic recording slave medium 10 with the residual number X having been judged to be greater than the permissible value a may be subjected to the cleaning step (S2) again.

As described above, according to the present embodiment, it is possible to confirm the number of grains of fine powder remaining on the peripheral edge 12 and the front surface 15 of the magnetic recording slave medium 10 after the cleaning step, and surely enhance adhesion between the magnetic recording slave medium 10 and the magnetic transfer master carrier 20 based upon the result of the confirmation.

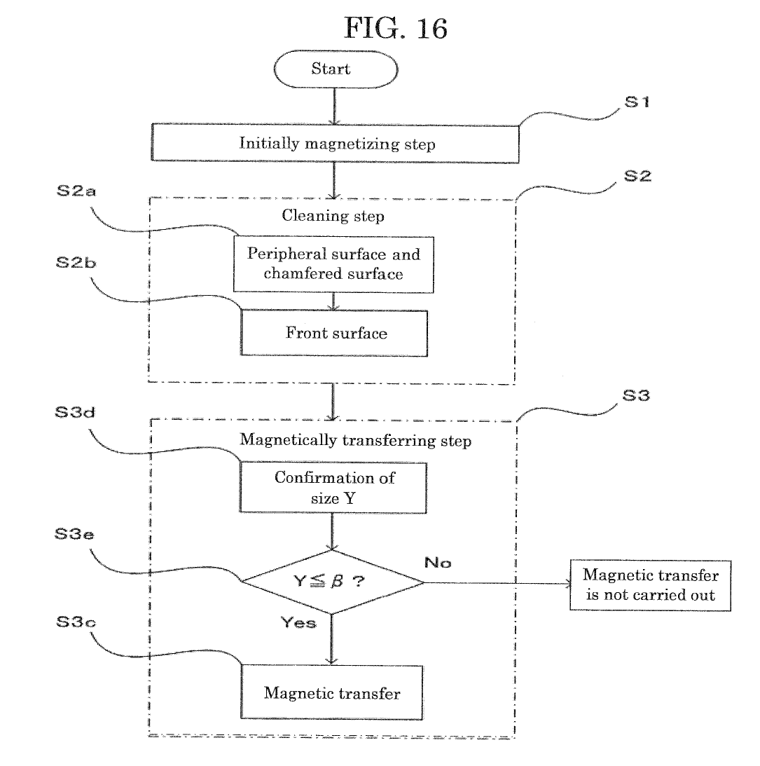

FIG. 16 is an explanatory diagram showing a procedure in a magnetic transfer method according to yet another embodiment of the present invention. Although the magnetic transfer method of this embodiment includes an initially magnetizing step (S1), a cleaning step (S2) and a magnetically transferring step (S3) similarly to the methods of the above-mentioned embodiments, the method of this embodiment differs from the methods of the above-mentioned embodiments as follows: in the magnetically transferring step (S3), the size of grains of fine powder remaining on the peripheral edge 12 and the front surface 15 of the magnetic recording slave medium 10 is confirmed, and magnetic transfer is judged to be possible or impossible based upon the result of the confirmation. The following explains the magnetically transferring step (S3) in the magnetic transfer method according to this embodiment.

As shown in FIG. 16, after the cleaning step (S2), the size of grains of fine powder remaining on the peripheral edge 12 and the front surface 15 of the magnetic recording slave medium is confirmed. Specifically, a visual external inspection is carried out using Micro-MAX (VMX-2100, manufactured by Vision Psytec Co., Ltd.), for example, and the size Y of grains of fine powder remaining on the peripheral edge 12 and the front surface 15 is calculated (S3d). Here, the size of the grains of the fine powder on the peripheral edge 12 is denoted by Y₁, and the size of the grains of the fine powder on the front surface 15 is denoted by Y₂.

Subsequently, as shown in FIG. 16, whether magnetic transfer is possible or impossible is judged (S3e) by judging whether or not the residual number X exceeds a permissible value β. The permissible value β is a value which is appropriately set, for example based upon a result concerning an occurrence of imperfect signal transmission at the time of magnetic transfer. Here, the permissible value for the size Y₁ of the grains of the fine powder on the peripheral edge 12 is denoted by β₁, and the permissible value for the size Y₂ of the grains of the fine powder on the front surface 15 is denoted by β₂.

When even one grain of fine powder, that has a prescribed size or larger is present on the front surface 15, magnetic transfer can be hindered. Also, when grains of fine powder that have a prescribed size or larger are present on the peripheral edge 12, it is highly likely that they move from the peripheral edge 12 to the front surface 15, thereby hindering magnetic transfer.

Accordingly, in the present embodiment, the presence of grains of fine powder that have a prescribed size or larger is confirmed before magnetic transfer. For the above-mentioned reasons and the like, when the size Y of the grains of the fine powder is greater than the permissible value β, magnetic transfer is not carried out.

For example, in the case where the permissible value β is set at 10 μm, magnetic transfer is not carried out even regarding a magnetic recording slave medium with only one grain of fine powder, whose size Y is 10 μm or greater.

Meanwhile, when the size Y of all grains of fine powder is less than or equal to the permissible value β, magnetic transfer is carried out (S3c).

The magnetic recording slave medium 10 with the size Y having been judged to be greater than the permissible value β may be subjected to the cleaning step (S2) again.

As described above, according to the present embodiment, it is possible to confirm grains of fine powder, whose size is greater than the permissible value A, remaining on the peripheral edge 12 and the front surface 15 of the magnetic recording slave medium 10 after the cleaning step, and surely enhance adhesion between the magnetic recording slave medium 10 and the magnetic transfer master carrier 20 based upon the result of the confirmation.

Further, in a magnetic transfer method according to still yet another embodiment, both the residual number X and the size Y of grains of fine powder may be judged.

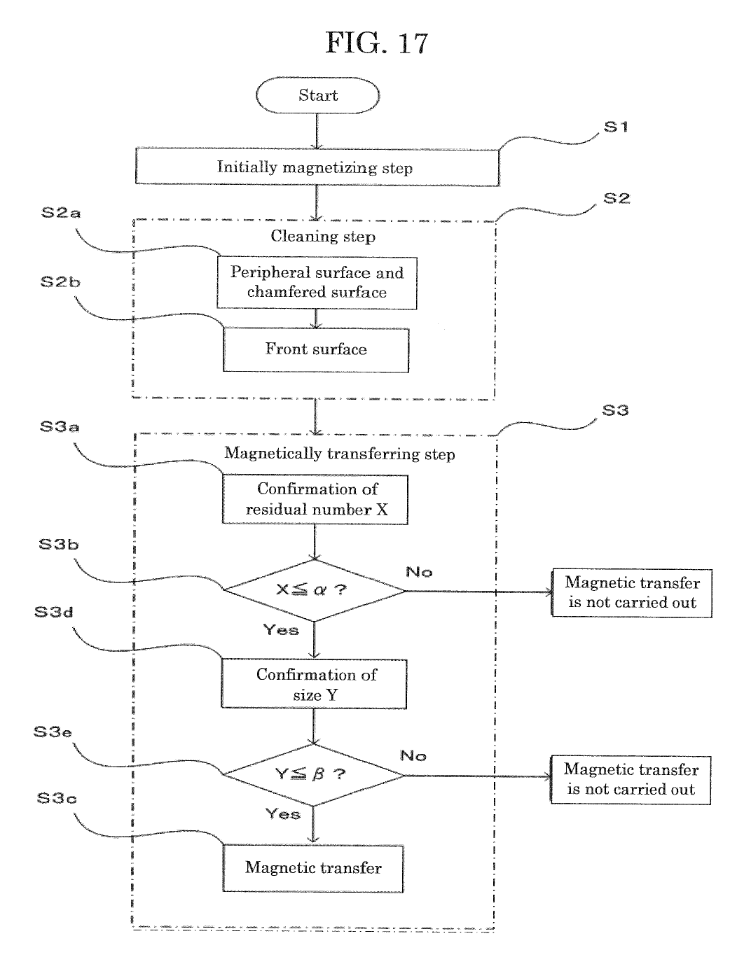

FIG. 17 is an explanatory diagram showing a procedure in a magnetic transfer method according to still yet another embodiment of the present invention. Although the magnetic transfer method of this embodiment includes an initially magnetizing step (S1), a cleaning step (S2) and a magnetically transferring step (S3) similarly to the methods of the above-mentioned embodiments, the method of this embodiment differs from the methods of the above-mentioned embodiments as follows: in the magnetically transferring step (S3), firstly, the number (residual number) of grains of fine powder remaining on the peripheral edge 12 and the front surface 15 of the magnetic recording slave medium 10 is confirmed, and magnetic transfer is judged to be possible or impossible based upon the result of the confirmation; subsequently, the size of the grains of the fine powder remaining on the peripheral edge 12 and the front surface 15 of the magnetic recording slave medium 10 is confirmed, and magnetic transfer is judged to be possible or impossible based upon the result of the confirmation.

Details of steps S3a, S3b, S3d, S3e and S3c in the magnetically transferring step (S3) are similar to those of the corresponding steps in the above-mentioned embodiments.

### EXAMPLES

The following explains Examples of the present invention. It should, however, be noted that the present invention is not confined to these Examples.

### Example A-1

### Production of Mold Structure

### <Original Master>

In accordance with the method shown in FIGS. 4F to 4J, a minute pattern based upon data tracks and servo information to be recorded on a hard disk (discrete track medium) was written into a silicon substrate provided with a photoresist layer, then these members were subjected to developing, etching, etc. so as to produce an original master.

As to the written area of this original master, the radius was 25 mm to 30 mm, the track pitch was 90 nm, the width of a groove structure that lies between the data tracks to divide them was 30 nm, and the depth of the groove structure was 60 nm.

The original master was subjected to a separability enhancing treatment by being immersed in a fluorine solvent solution (FOMBLIN Z-TETRAOL, produced by Solvay Solexis), then annealed and rinsed. The average adsorption film thickness of the fluorine solvent solution (Z-TETRAOL) was adjusted to 1.0 nm.

### <Mold Structure>

In accordance with a UV nanoimprinting method, a quartz mold structure was produced using the original master (see FIGS. 1 and 3A to 3E).

First of all, as a quartz substrate (original plate), a plate which had a diameter of 6 inches and a thickness of 0.7 mm and was made of synthetic quartz was prepared, and fine powder on an edge of the quartz substrate was removed using the removing unit shown in FIG. 1 (cleaning step).

As the wiping tape, KRAUSEN (EW-NC-310, produced by Technos Co., Ltd.) was used. The hardness of the sponge roller was set at 15°, and the pressing pressure of the sponge roller was set at 40 gf.

The rotational speed of the quartz substrate was set at 200 rpm, and the processing time was set at 2 sec.

After the cleaning step, an imprint resist layer was formed on a surface of the quartz substrate so as to have a thickness of 25 nm (imprint resist layer forming step).

Thereafter, using the original master, a resist pattern which was an inversion of the concavo-convex pattern of the original master was formed on the imprint resist layer on the surface of the quartz substrate (resist pattern forming step) by a UV nanoimprinting apparatus employing a fluid pressurization system. The thickness of each concave portion in the resist pattern was 17 nm.

The above-mentioned steps were carried out on 100 quartz substrates (original plates), using the original master.

### [Evaluation 1]

### (Evaluation of Resist Pattern)

The resist patterns formed on the surfaces of the first, 10th and 100th quartz substrates were evaluated.

As to the evaluation method, the resist patterns were irradiated with strong halogen light, and the number of defects arising on each resist pattern was counted. In patterned areas, white shining dots were judged to be defects.

As a result, no defect was found on any of these resist patterns.

### [Evaluation 2]

### (Evaluation of Concavo-Convex Pattern of Original Master)

The states of the concavo-convex pattern of the original master at the times when the resist patterns were formed on the surfaces of the first, 10th and 100th quartz substrates were evaluated.

As to the evaluation method, similarly to the above-mentioned method of counting the number of defects, the concavo-convex pattern of the original master was irradiated with strong halogen light, and the number of defects arising on the pattern was counted.

As a result, no defect was found on the concavo-convex pattern of the original master at any of the times.

### [Evaluation 3]

### (Evaluation of Concavo-Convex Pattern of Mold Structure)

Thereafter, in accordance with the method shown in FIGS. 3D and 3E, a quartz mold structure was obtained from the 100th quartz substrate. Specifically, the resist corresponding to concave portions was removed in an ashing (etching) step using oxygen gas, the subsequently exposed quartz substrate was etched in a reactive ion etching step using CFx gas, and a concavo-convex shape corresponding to the resist pattern was formed in the quartz substrate. Afterward, the resist remaining on convex portions of the quartz substrate was removed, and a quartz mold structure was thus obtained. The concavo-convex pattern of the quartz mold structure was 70 nm in depth.

The concavo-convex pattern (patterned area) of the quartz mold structure produced using the 100th quartz substrate was irradiated with strong halogen light, and the number of defects arising in the patterned area was counted. In the patterned area, white shining dots were judged to be defects.

As a result, the number of defects arising in the patterned area of the quartz mold structure was only two.

### Example A-2

### Production of Magnetic Recording Medium

### <Mold Structure>

A magnetic recording medium (discrete track medium) was produced, using the quartz mold structure obtained from the 100th quartz substrate, produced in Example A-1.

Firstly, the surface of the quartz mold structure was subjected to a separability enhancing treatment with Z-TETRAOL by a method similar to the method for the silicon original master in Example A-1.

### <Magnetic Original Plate>

By a sputtering method, a 100 nm soft magnetic layer made of FeCo alloy, a 20 nm intermediate layer made of Ru, a 15 nm magnetic layer made of CoPtCr—SiO₂ alloy, and a 5 nm protective layer made of carbon were formed in this order over a 2.5-inch crystallized glass substrate (supporting plate), and the substrate and the layers constituted a magnetic original plate.

An edge surface of the magnetic original plate was cleaned using the removing unit shown in FIG. 1.

As the wiping tape, KRAUSEN (EW-NC-310, produced by Technos Co., Ltd.) was used. The hardness of the sponge roller was set at 15°, and the pressing pressure of the sponge roller was set at 40 gf. The rotational speed of the magnetic original plate was set at 200 rpm, and the processing time was set at 2 sec.

As shown in FIG. 5K, a UV-curable imprint resist was applied onto this magnetic original plate so as to have a thickness of 30 nm (imprint resist layer forming step), and then nanoimprinting was carried out (resist pattern forming step; see FIG. 5L).

The nanoimprinting was carried out on 100 magnetic original plates.

The resist structure (resist pattern) produced on each magnetic original plate was a concavo-convex structure which was an inversion of the concavo-convex structure (concavo-convex pattern) of the quartz mold structure. The resist film thickness at concave portions in the concavo-convex structure was 15 nm.

### [Evaluation 4]

### (Evaluation of Resist Pattern)

The resist patterns formed on the surfaces of the first, 10th and 100th magnetic original plates were evaluated.

As to the evaluation method, the resist patterns were irradiated with strong halogen light, and the number of defects arising on each resist pattern was counted.

As a result, the numbers of defects on the resist patterns were two (with respect to the first magnetic original plate), five (with respect to the 10th magnetic original plate) and five (with respect to the 100th magnetic original plate), respectively.

### [Evaluation 5]

### (Evaluation of Concavo-Convex Pattern of Mold Structure)

The states of the concavo-convex pattern of the mold structure at the times when the resist patterns were formed on the surfaces of the first, 10th and 100th magnetic original plates were evaluated.

As to the evaluation method, similarly to the above-mentioned methods of counting the number of defects, the concavo-convex pattern of the mold structure was irradiated with strong halogen light, and the number of defects arising on the pattern was counted with respect to each magnetic original plate.

As a result, the numbers of defects on the concavo-convex pattern of the mold structure were three (with respect to the first magnetic original plate), five (with respect to the 10th magnetic original plate) and six (with respect to the 100th magnetic original plate), respectively.

### [Evaluation 6]

### (Evaluation of Concavo-Convex Pattern of Magnetic Recording Medium)

Thereafter, in accordance with the method shown in FIGS. 6N and 6O, the 100th magnetic original plate was processed into a discrete track medium.

Specifically, the carbon protective layer and the resist corresponding to concave portions were removed in an ashing (etching) step using oxygen gas, the subsequently exposed magnetic layer was etched in an etching step using Ar gas (magnetic layer etching step), and a concavo-convex shape corresponding to the resist pattern was formed in the magnetic layer. Afterward, the resist remaining on convex portions of the magnetic layer was removed, and a magnetic recording medium was thus obtained. The magnetic layer was processed by a depth of 12 nm.

The concavo-convex pattern (patterned area) of the magnetic recording medium produced using the 100th magnetic original plate was irradiated with strong halogen light, and the number of defects arising in the patterned area was counted. In the patterned area, white shining dots were judged to be defects.

As a result, the number of defects arising in the patterned area of the magnetic recording medium was only five.

### Comparative Example A-1

### Production of Mold Structure

### <Original Master>

An original master was produced under the same conditions as those of Example A-1.

### <Mold Structure>

A resist pattern was formed on a surface of a quartz substrate, using the original master, in a manner similar to Example A-1, except that the cleaning step was not carried out.

Thereafter, a mold structure was produced by processing the quartz substrate, with the resist pattern used as a mask, in a manner similar to Example A-1.

These processes were carried out on 100 quartz substrates (original plates), using the original master.

### [Evaluation 1]

### (Evaluation of Resist Pattern)

The resist patterns formed on the surfaces of the first, 10th and 100th quartz substrates were evaluated.

As to the evaluation method, similarly to the method in Example A-1, the resist patterns were irradiated with strong halogen light, and the number of defects arising on each resist pattern was counted.

As a result, the numbers of defects on the resist patterns were 5 (with respect to the first quartz substrate), 14 (with respect to the 10th quartz substrate) and 45 (with respect to the 100th quartz substrate), respectively.

### [Evaluation 2]

### (Evaluation of Concavo-Convex Pattern of Original Master)

The states of the concavo-convex pattern of the original master in Comparative Example 1 at the times when the resist patterns were formed on the surfaces of the first, 10th and 100th quartz substrates were evaluated.

As to the evaluation method, similarly to the above-mentioned methods of counting the number of defects, the concavo-convex pattern of the original master was irradiated with strong halogen light, and the number of defects arising on the pattern was counted.

As a result, the numbers of defects on the concavo-convex pattern of the original master were 2 (with respect to the first quartz substrate), 17 (with respect to the 10th quartz substrate) and 51 (with respect to the 100th quartz substrate), respectively.

### [Evaluation 3]

### (Evaluation of Concavo-Convex Pattern of Mold Structure)

Thereafter, in a manner similar to Example A-1, a quartz mold structure was obtained from the 100th quartz substrate. The concavo-convex pattern of the quartz mold structure was 70 nm in depth.

In a manner similar to Example A-1, the concavo-convex pattern (patterned area) of the quartz mold structure produced using the 100th quartz substrate was irradiated with strong halogen light, and the number of defects arising in the patterned area was counted. In the patterned area, white shining dots were judged to be defects.

As a result, the number of defects arising in the patterned area of the quartz mold structure was 49.

### Comparative Example A-2

### Production of Magnetic Recording Medium

### <Mold Structure>

A magnetic recording medium (discrete track medium) was produced, using the quartz mold structure produced in Comparative Example 1, in a manner similar to Example A-2, except that an edge surface of a magnetic original plate was not cleaned.

In a manner similar to Example A-2, nanoimprinting was carried out on 100 magnetic original plates. The resist structure (resist pattern) produced on each magnetic original plate was a concavo-convex structure which was an inversion of the concavo-convex structure (concavo-convex pattern) of the quartz mold structure. The resist film thickness at concave portions in the concavo-convex structure was 15 nm.

### [Evaluation 4]

### (Evaluation of Resist Pattern)

The resist patterns formed on the surfaces of the first, 10th and 100th magnetic original plates were evaluated.

As to the evaluation method, similarly to the method in Example A-2, the resist patterns were irradiated with strong halogen light, and the number of defects arising on each resist pattern was counted.

As a result, the numbers of defects on the resist patterns were 10 (with respect to the first magnetic original plate), 30 (with respect to the 10th magnetic original plate) and 109 (with respect to the 100th magnetic original plate), respectively.

### [Evaluation 5]

### (Evaluation of Concavo-Convex Pattern of Mold Structure)

The states of the concavo-convex pattern of the mold structure at the times when the resist patterns were formed on the surfaces of the first, 10th and 100th magnetic original plates were evaluated.

As to the evaluation method, similarly to the above-mentioned methods of counting the number of defects, the concavo-convex pattern of the mold structure was irradiated with strong halogen light, and the number of defects arising on the pattern was counted.

As a result, the numbers of defects on the concavo-convex pattern of the mold structure were 3 (with respect to the first magnetic original plate), 25 (with respect to the 10th magnetic original plate) and 88 (with respect to the 100th magnetic original plate), respectively.

### [Evaluation 6]

### (Evaluation of Concavo-Convex Pattern of Magnetic Recording Medium)

Thereafter, in a manner similar to Example A-2, a discrete track medium (magnetic recording medium) was produced using the 100th magnetic original plate. The magnetic layer was processed by a depth of 12 nm.

The concavo-convex pattern (patterned area) of the magnetic recording medium produced was irradiated with strong halogen light, and the number of defects arising in the patterned area was counted. In the patterned area, white shining dots were judged to be defects.

As a result, the number of defects arising in the patterned area of the magnetic recording medium was 120.

### Example B-1

### Production of Magnetic Recording Slave Medium

Magnetic recording slave media of Example B-1 were produced, with each of them produced as follows. A glass substrate having a diameter of 2.5 inches was prepared, and layers were formed over this glass substrate in accordance with the following procedure so as to produce a magnetic recording slave medium of a perpendicular magnetic recording system. At a peripheral edge of the glass substrate, a peripheral surface and a chamfered surface were formed. Note that the peripheral edge of the glass substrate is equivalent to the peripheral edge of the magnetic recording slave medium.

A soft magnetic layer, a first nonmagnetic orientational layer, a second nonmagnetic orientational layer, a magnetic layer, a protective layer and a lubricant layer were sequentially formed to constitute the magnetic recording slave medium. The soft magnetic layer, the first nonmagnetic orientational layer, the second nonmagnetic orientational layer, the magnetic layer and the protective layer were formed by sputtering, and the lubricant layer was formed by dipping.

### (Formation of Soft Magnetic Layer)

As the soft magnetic layer, a CoZrNb film was formed so as to have a thickness of 100 nm.

Specifically, the glass substrate was placed facing a CoZrNb target, Ar gas was introduced such that the pressure became 0.6 Pa, and the soft magnetic layer was deposited with electric discharge at a DC power of 1,500 W.

### (Formation of First Nonmagnetic Orientational Layer)

As the first nonmagnetic orientational layer, a Ti film was formed so as to have a thickness of 5 nm.

Specifically, the glass substrate over which the soft magnetic layer had been formed was placed facing a Ti target, Ar gas was introduced such that the pressure became 0.5 Pa, and the first nonmagnetic orientational layer was deposited with electric discharge at a DC power of 1,000 W.

### (Formation of Second Nonmagnetic Orientational Layer)

As the second nonmagnetic orientational layer, a Ru film was formed so as to have a thickness of 6 nm.

Specifically, the glass substrate over which the first nonmagnetic orientational layer had been formed was placed facing a Ru target, Ar gas was introduced such that the pressure became 0.8 Pa, and the second nonmagnetic orientational layer was deposited with electric discharge at a DC power of 900 W.

### (Formation of Magnetic Layer)

As the magnetic layer, a CoCrPtO film was formed so as to have a thickness of 18 nm.

Specifically, the glass substrate over which the second nonmagnetic orientational layer had been formed was placed facing a CoCrPtO target, Ar gas containing 0.06% of O₂ was introduced such that the pressure became 14 Pa, and the magnetic layer was deposited with electric discharge at a DC power of 290 W.

### (Formation of Protective Layer)

As the protective layer, a Carbon film was formed so as to have a thickness of 4 nm.

Specifically, the glass substrate over which the magnetic layer had been formed was placed facing a C target, Ar gas was introduced such that the pressure became 0.5 Pa, and the protective layer was deposited with electric discharge at a DC power of 1,000 W.

### (Formation of Lubricant Layer)

As the lubricant layer, a layer made of a PFPE lubricant was formed so as to have a thickness of 2 nm. Thereafter, fine protrusions and fine powder present on the surface were removed with a burnishing tape.

The coercive force of the magnetic recording slave medium was 334 kA/m (4.2 kOe).

### [Initial Magnetization]

The magnetic recording slave medium was initially magnetized by applying a DC magnetic field to the magnetic recording slave medium. The strength of the magnetic field applied was 10 kOe.

### [Cleaning]

### (Cleaning of Peripheral Edge)

As shown in FIG. 10, the wiping tape was pressed against the peripheral edge of the magnetic recording slave medium, using the sponge roller, and while the magnetic recording slave medium was being rotated, fine powder present on the peripheral surface and the chamfered surface of the peripheral edge was wiped away.

As the wiping tape, KRAUSEN (EW-NC-310, produced by Technos Co., Ltd.) was used.

The hardness of the sponge roller was set at 15°, and the pressing pressure of the sponge roller was set at 40 gf.

The rotational speed of the magnetic recording slave medium was set at 200 rpm, and the processing time was set at 2 sec.

### (Cleaning of Front Surface)

As shown in FIG. 12, the wiping tape was pressed against the front surface of the magnetic recording slave medium, using the sponge pad, and while the magnetic recording slave medium was being rotated, fine powder present on the front surface was wiped away.

As the wiping tape, KRAUSEN (EW-NC-110, produced by Technos Co., Ltd.) was used.

The hardness of the sponge pad was set at 25°, and the pressing pressure of the sponge pad was set at 50 gf.

The rotational speed of the magnetic recording slave medium was set at 2,000 rpm, and the processing time was set at 2 sec.

### [Measurement of Remaining Fine Powder]

The numbers of grains (particles) of fine powder remaining on the peripheral edge and the front surface of the magnetic recording slave medium were counted using a minute defect visualizing inspection device (Micro-MAX), after the peripheral edge had been cleaned.

The size of the grains of the fine powder was calculated from images obtained using a CCD camera.

Also, the numbers of grains of fine powder remaining on the peripheral edge and the front surface of the magnetic recording slave medium were counted using the device, after the front surface had been cleaned.

Additionally, for reference, the numbers of grains of fine powder remaining on the peripheral edge and the front surface of the magnetic recording slave medium were counted, before cleaning the peripheral edge and the front surface.

### [Judgmental Criteria for Carrying Out Magnetic Transfer]

The permissible value α₁ for the number (residual number) X₁ of grains of fine powder present on the peripheral edge 12 was defined as 50, and the permissible value α₂ for the number (residual number) X₂ of grains of fine powder present on the front surface 15 was defined as 10.

As for the permissible value β for the size of the grains of the fine powder, both β₁ and β₂ were defined as 10 μm.

The results are shown in Table B-1.

TABLE B-1

| | Percentage of magnetic recording | | Percentage of |
|---|---|---|---|
| | slave media satisfying | | successful |
| | permissible value (%) | | magnetic |
| | Front surface | Peripheral edge | transfer (%) |
| Before cleaning | 89 | 68 | 60 |
| After cleaning | 78 | 93 | 73 |
| (Peripheral edge) | | | |
| After cleaning | 91 | 93 | 85 |
| (Front surface) | | | |

As shown in Table B-1, regarding the percentages of successful magnetic transfer with the magnetic recording slave media of Example B-1, the cleaned magnetic recording slave media yielded better results than those not yet cleaned.

### [Production of Magnetic Transfer Master Carrier]

### (Original Master)

An electron beam resist was applied onto an 8-inch Si wafer (original plate) by spin coating so as to have a thickness of 100 nm. After the application, the resist on the original plate was irradiated with an electron beam modulated correspondingly to servo information, etc., using a rotary electron beam exposure apparatus, so as to expose the resist. Thereafter, the resist was developed, unexposed portions were removed, and a pattern composed of the resist was thus formed on the original plate.

Subsequently, the original plate was subjected to reactive etching, with the patterned resist used as a mask, and hollows were formed at places not masked with the resist. After this etching, the resist remaining on the original plate was removed by being washed with a solvent. Thereafter, the original plate was dried, and an original master for producing a magnetic transfer master carrier was thus obtained.

### (Magnetic Transfer Master Carrier)

A conductive layer (10 nm in thickness) made of Ni was formed over the original master by sputtering. Thereafter, a Ni layer was formed over the original master by electroforming, using as a matrix the original master over which the conductive layer was formed. Subsequently, the Ni layer was separated from the original master, the Ni layer was subjected to washing, etc., and a Ni base material with convex portions arranged on its surface was thus obtained.

Subsequently, the Ni base material was set in a predetermined chamber, and an FeCo film (Fe70_Co30 atomic %) (20 nm in thickness) as a magnetic layer was formed over the convex portions of the Ni base material by sputtering. The deposition condition was as follows.

### <Deposition Condition>

Deposition pressure: 0.3 Pa, Distance between Ni base material and target: 200 mm, DC power: 1,000 W

A magnetic transfer master carrier was thus produced.

### [Magnetic Transfer]

The magnetic transfer master carrier was closely attached to a magnetic recording slave medium which had undergone the cleaning step. The pressure at the time of the close attachment was set at 9 kg/cm².

Thereafter, with these closely attached to each other, a recording magnetic field was applied. The strength of the magnetic field was 4.2 kOe.

Subsequently, the recording magnetic field stopped being applied, and the magnetic transfer master carrier was separated from the magnetic recording slave medium.

### [Evaluation of Performance of Magnetic Transfer]

One hundred magnetic recording slave media were subjected to the cleaning step, then information was magnetically transferred to all these magnetic recording slave media, and an judgment was made about whether or not imperfect signal transmission had happened to a servo signal recorded on the magnetic recording slave medium to which the information had been magnetically transferred for the 100th time. As to the judgment about imperfect signal transmission, the sector-by-sector TAA (track average amplitude) reproduction output of a preamble section was detected in all radius positions at a pitch of 0.1 mm, and the judgmental criterion was defined by whether or not the values of the reproduction output were equivalent to 70% or less of the average values of the reproduction output in the radius positions. As an evaluating device, LS-90 manufactured by Kyodo electronics inc. was used. As a magnetic head, a GMR head with a read width of 120 nm and a write width of 200 nm was used.

As a result, imperfect signal transmission was not detected regarding the servo signal recorded on the magnetic recording slave medium to which the information had been magnetically transferred for the 100th time.

### Example B-2

### Magnetic Recording Slave Medium

Magnetic recording slave media of Example B-2 were produced in a manner similar to Example B-1.

### [Initial Magnetization]

Each magnetic recording slave medium was initially magnetized in a manner similar to Example B-1.

### [Cleaning Step]

A front surface and a peripheral edge of the magnetic recording slave medium were cleaned in a manner similar to Example B-1, except that the front surface was cleaned first and then the peripheral edge was cleaned.

### [Measurement of Remaining Fine Powder]

In a manner similar to Example B-1, the numbers of grains (particles) of fine powder remaining on the peripheral edge and the front surface of the magnetic recording slave medium were counted using a minute defect visualizing inspection device (Micro-MAX), after the front surface had been cleaned.

Also, the numbers of grains of fine powder remaining on the peripheral edge and the front surface of the magnetic recording slave medium were counted using the device, after the peripheral edge had been cleaned.

Additionally, for reference, the numbers of grains of fine powder remaining on the peripheral edge and the front surface of the magnetic recording slave medium were counted, before cleaning the front surface and the peripheral edge.

The results are shown in Table B-2.

TABLE B-2

| | Percentage of magnetic recording | | Percentage of |
|---|---|---|---|
| | slave media satisfying | | successful |
| | permissible value (%) | | magnetic |
| | Front surface | Peripheral edge | transfer (%) |
| Before cleaning | 89 | 68 | 60 |
| After cleaning | 90 | 79 | 71 |
| (Front surface) | | | |
| After cleaning | 85 | 92 | 78 |
| (Peripheral edge) | | | |

As shown in Table B-2, regarding the percentages of successful magnetic transfer with the magnetic recording slave media of Example B-2, the cleaned magnetic recording slave media yielded better results than those not yet cleaned.

Here, the percentage of the magnetic recording slave media satisfying the permissible value for their peripheral edges increased from 68 to 79 after their front surfaces had been cleaned; it is inferred that this is because part of the fine powder on the peripheral edges had been wiped away as part of the wiping tape came into contact with the surfaces of the peripheral edges in the cleaning of the front surfaces.

### [Magnetic Transfer]

In a manner similar to Example B-1, information was magnetically transferred to the magnetic recording slave media, using the magnetic transfer master carrier produced in Example B-1.

### [Evaluation of Performance of Magnetic Transfer]

As a result of carrying out an evaluation similar to that in Example B-1, imperfect signal transmission was not detected regarding a servo signal recorded on the magnetic recording slave medium to which the information had been magnetically transferred for the 100th time.

### Comparative Example B

The magnetic recording slave media of Example B-2, with only the front surfaces thereof having been cleaned, are defined as magnetic recording slave media of Comparative Example B.

As shown in Table B-2, as to the percentages of the magnetic recording slave media satisfying the permissible values, with only the front surfaces thereof having been cleaned, the percentage regarding the front surfaces was 90%, and the percentage regarding the peripheral edges was 79%.

### [Magnetic Transfer]

In a manner similar to Example B-1, information was magnetically transferred to the magnetic recording slave media, using the magnetic transfer master carrier produced in Example B-1.

### [Evaluation of Performance of Magnetic Transfer]

As a result of carrying out an evaluation similar to that in Example B-1, imperfect signal transmission was detected in two places regarding a servo signal recorded on the magnetic recording slave medium to which the information had been magnetically transferred for the 100th time.

The percentage regarding the front surfaces was close to the corresponding percentages in Examples B-1 and B-2, but the percentage regarding the peripheral edges was lower than those in Examples B-1 and B-2. As already described, when fine powder remains on the peripheral edge of a magnetic recording slave medium, the fine powder moves from the peripheral edge to the front surface thereof at the time of magnetic transfer, thereby hindering the magnetic transfer and causing breakage of a magnetic transfer master carrier.

What is claimed is:

1. A resist pattern forming method comprising:
cleaning off fine powder at least on an edge of a base material to be processed,
forming an imprint resist layer on a surface of the base material whose edge has been cleared of the fine powder, and
forming a resist pattern on the surface of the base material by pressing, against the imprint resist layer, a concavo-convex pattern which is provided in a surface of a concavo-convex mold and which is composed of a plurality of convex portions and concave portions formed between the convex portions, so that the resist pattern is an inversion of the concavo-convex pattern.

2. A method for producing a mold structure, comprising:
using a resist pattern forming method, and
etching a surface of an original plate using, as a mask, a resist pattern that has been formed on the surface of the original plate by the resist pattern forming method so as to form hollows in the original plate and thus to obtain a mold structure which is composed of a substrate obtained by forming the follows in the original plate, and convex portions provided on a surface of the substrate,
wherein the resist pattern forming method comprises cleaning off fine powder at least on an edge of the original plate; forming an imprint resist layer on the surface of the original plate whose edge has been cleared of the fine powder; and forming the resist pattern on the surface of the original plate by pressing, against the imprint resist layer, a concavo-convex pattern which is provided in a surface of an original master and which is composed of a plurality of convex portions and concave portions formed between the convex portions, so that the resist pattern is an inversion of the concavo-convex pattern.

3. A magnetic transfer method comprising:
initially magnetizing a magnetic recording slave medium by applying a DC magnetic field to the magnetic recording slave medium,
cleaning off fine powder present on a chamfered surface and a peripheral surface of the magnetic recording slave medium, and also cleaning off fine powder present on a circular surface of the magnetic recording slave medium, and
magnetically transferring information by applying a recording magnetic field, with a magnetic transfer master carrier closely attached to the magnetic recording slave medium,
wherein the magnetic recording slave medium is shaped like a disc and has the chamfered surface at sides of the peripheral surface.

4. The magnetic transfer method according to claim 3, wherein in the cleaning of the magnetic recording slave medium, after the fine powder present on the chamfered surface and the peripheral surface of the magnetic recording slave medium has been cleaned off, the fine powder present on the circular surface of the magnetic recording slave medium is cleaned off.

5. The magnetic transfer method according to claim 3, wherein in the magnetic transfer of the information, the number of grains of the fine powder remaining on at least one of the circular surface, the chamfered surface and the peripheral surface after the cleaning of the magnetic recording slave medium is confirmed, and the information is magnetically transferred to the magnetic recording slave medium when the number of the grains is less than or equal to a permissible value, whereas the information is not magnetically transferred to the magnetic recording slave medium when the number of the grains is greater than the permissible value.

6. The magnetic transfer method according to claim 3, wherein in the magnetic transfer of the information, the size of grains of the fine powder remaining on at least one of the circular surface, the chamfered surface and the peripheral surface after the cleaning of the magnetic recording slave medium is confirmed, and the information is magnetically transferred to the magnetic recording slave medium when the size of the grains is less than or equal to a permissible value, whereas the information is not magnetically transferred to the magnetic recording slave medium when the size of the grains is greater than the permissible value.
